(19) United States
(12) Patent Application Publication
(10) Pub. No.: US 2009/0168456 A1
(43) Pub. Date: Jul. 2, 2009

(54) LIGHT SOURCE MODULE FOR A DISPLAY DEVICE AND A DISPLAY DEVICE HAVING THE SAME

(76) Inventors: Se-Ki PARK, Suwon-si (KR); Gi-Cherl KIM, Yongin-si (KR); Sang-Il PARK, Seoul (KR)

Correspondence Address: F. CHAU & ASSOCIATES, LLC, 130 WOODBURY ROAD, WOODBURY, NY, 11797, US

(21) Appl. No.: 12/247,669

(22) Filed: Oct. 8, 2008

(30) Foreign Application Priority Data
Jan. 2, 2008 (KR) 10-2008-0000274

(51) Int. Cl. F21V 7/00; F21V 21/00

(52) U.S. Cl. 362/613

(57) ABSTRACT

A light source module including: a light guide plate having first side surfaces opposite each other and second side surfaces opposite each other, wherein each of the first side surfaces has a length of m and each of the second side surfaces has a length of n, and wherein n≦m; a first light source that is disposed adjacent to one of the first side surfaces; and second and third light sources that are disposed adjacent to the second side surfaces, respectively, wherein an output luminance of the first light source is different from an output luminance of the second light source.

### CROSS REFERENCE TO RELATED APPLICATION

This application claims priority to Korean Patent Application No. 10-2008-0000274 filed on Jan. 2, 2008, in the Korean Intellectual Property Office, the disclosure of which is incorporated by reference herein in its entirety.

### BACKGROUND OF THE INVENTION

1. Technical Field

The present invention relates to a light source module for a display device that can improve luminance of an edge type light source module and provide light having uniform distribution, and a display device having the light source module.

2. Discussion of the Related Art

A liquid crystal display (LCD), which is generally employed as a flat panel display device, is a passive light-emitting element that cannot emit light by itself. Therefore, an LCD requires a separate light source module, such as a backlight, to display an image.

A light-emitting diode (LED) having advantages, such as long life, low power consumption, light weight, and the ability to be made thin, is used as a light source of the light source module. However, the LED is a spot light source. For this reason, a light source module, which has the form of a line light source or a surface light source, has been manufactured by using a plurality of LEDs.

In such a light source module, the maximum amount of light radiated from each of the LEDs is limited. As a result, the number of LEDs needed for a high luminance display panel is large. However, when many LEDs are disposed per unit area, they are damaged due to heat radiated therefrom. Further, since the temperature of the light source module and the display panel increases due to the heat radiated from the LEDs, the reliability of a nearby electronic circuit deteriorates. Furthermore, optical characteristics of the LEDs are changed due to the heat, which causes a variation in the output luminance of the LEDs, thereby making the output luminance of the light source module nonuniform.

Accordingly, there exists a need for a light source module that can provide uniform light distribution.

### SUMMARY OF THE INVENTION

In an exemplary embodiment of the present invention, a light source module comprises: a light guide plate having first side surfaces opposite each other and second side surfaces opposite each other, wherein each of the first side surfaces has a length of m and each of the second side surfaces has a length of n, and wherein n≦m; a first light source that is disposed adjacent to one of the first side surfaces; and second and third light sources that are disposed adjacent to the second side surfaces, respectively, wherein an output luminance of the first light source is different from an output luminance of each of the second and third light sources.

When an output luminance of the light guide plate is L, the output luminance of each of the second and third light sources is larger than (½)(n/2)(mL/(m+n))(1/n) and equal to or smaller than (n/2)(mL/(m+n))(1/n). The output luminance of the first light source is nL/(m+n).

Each of the first to third light sources includes a plurality of light-emitting units, and each of the plurality of light-emitting units includes one or more light-emitting diodes. The number of the light-emitting units of the first light source is larger than the number of the light-emitting units of each of the second and third light sources.

The output luminance of the first light source is higher than the output luminance of each of the second and third light sources.

Each of the second and third light sources includes a plurality of light-emitting blocks that are sequentially disposed along the second side surfaces, and a luminance of each of the plurality of the light-emitting blocks is sequentially increased from a light-emitting block adjacent to the first light source to a light-emitting block farthest from the first light source.

A light-emitting block comprises one or more light-emitting diodes, one or more Cold Cathode Fluorescent Lamp (CCFLs), and one or more External Electrode Fluorescent Lamp (EEFLs).

In an exemplary embodiment of the present invention, a light source module comprises: a light guide plate having first side surfaces opposite each other and second side surfaces opposite each other, wherein each of the first side surfaces has a length of m and each of the second side surfaces has a length of n, and wherein n≦m; a first light source that is disposed adjacent to one of the first side surfaces; and second and third light sources that are disposed adjacent to the second side surfaces, respectively, wherein each of the second and third light sources includes a plurality of light-emitting blocks that are sequentially disposed along the second side surfaces, and a luminance of each of the plurality of the light-emitting blocks is sequentially increased from a light-emitting block adjacent to the first light source to a light-emitting block farthest from the first light source.

Each of the light-emitting blocks includes one or more light-emitting diodes, and a substrate on which the light-emitting diodes are mounted.

When an output luminance of the light guide plate is L, an output luminance of the first light source is nL/(m+n) and the sum of an output luminance of the light-emitting blocks of each of the second and third light sources is larger than (½)(n/2)(mL/(m+n))(1/n) and equal to or smaller than (n/2)(mL/(m+n))(1/n).

In an exemplary embodiment of the present invention, a display device comprises: a light source module including a light guide plate having first side surfaces opposite each other and second side surfaces opposite each other, wherein each of the first side surfaces has a length of m and each of the second side surfaces has a length of n, and wherein n≦m, a first light source that is disposed adjacent to one of the first side surfaces and that emits light having a first output luminance, and second and third light sources that are disposed adjacent to the second side surfaces, respectively, wherein each of the second and third light sources emits light having a second output luminance; and a display panel that displays an image by using light radiated from the light source module.

The display device further includes a control board that supplies image signals to the display panel. The control board is disposed adjacent to the first side surface opposite the first side surface having the first light source disposed adjacent thereto.

The first output luminance is higher than the second output luminance.

When an output luminance of the light guide plate is L, the second output luminance is larger than (½)(n/2)(mL/(m+n))(1/n) and equal to or smaller than (n/2)(mL/(m+n))(1/n). The first output luminance is nL/(m+n).

Each of the second and third light sources includes a plurality of light-emitting blocks that are sequentially disposed along the second side surfaces, and a luminance of each of the plurality of the light-emitting blocks is sequentially increased from a light-emitting block adjacent to the first light source to a light-emitting block farthest from the first light source.

The first output luminance is different from the second output luminance.

Each of the first to third light sources includes a plurality of light-emitting units, and each of the plurality of light-emitting units includes one or more light-emitting diodes.

The number of the light-emitting units of the first light source is larger than the number of the light-emitting units of each of the second and third light sources.

### BRIEF DESCRIPTION OF THE DRAWINGS

The above and other features of the present invention will become more apparent by describing in detail exemplary embodiments thereof with reference to the attached drawings in which:

FIG. 1 is an exploded perspective view of a display device according to an exemplary embodiment of the present invention;

FIG. 2 is a cross-sectional view of the assembled display device, taken along line A-A of FIG. 1;

FIG. 3 is a cross-sectional view of the assembled display device, taken along line B-B of FIG. 1;

FIG. 4 is a plan view of a light source according to an exemplary embodiment of the present invention;

FIG. 5 is a plan view of a light source according to an exemplary embodiment of the present invention;

FIG. 6 is a plan view of a light source module according to an exemplary embodiment of the present invention;

FIG. 7 is an exploded perspective view of a light source module according to an exemplary embodiment of the present invention;

FIG. 8 is an exploded perspective view of a light source module according to an exemplary embodiment of the present invention; and

FIG. 9 is a plan view of a light source module according to an exemplary embodiment of the present invention.

### DESCRIPTION OF EXEMPLARY EMBODIMENTS

Exemplary embodiments of the present invention will be described more fully hereinafter with reference to the accompanying drawings. The present invention may, however, be embodied in many different forms and should not be construed as being limited to the embodiments set forth herein.

The thicknesses of layers and regions may be exaggerated in the drawings to clarify various layers and regions, and like reference numerals refer to like elements in the drawings. That a first part such as a layer, an area, a substrate, etc. is provided “over” or “on” a second part may mean that the first part is provided directly on the second part, or that a third part is provided therebetween.

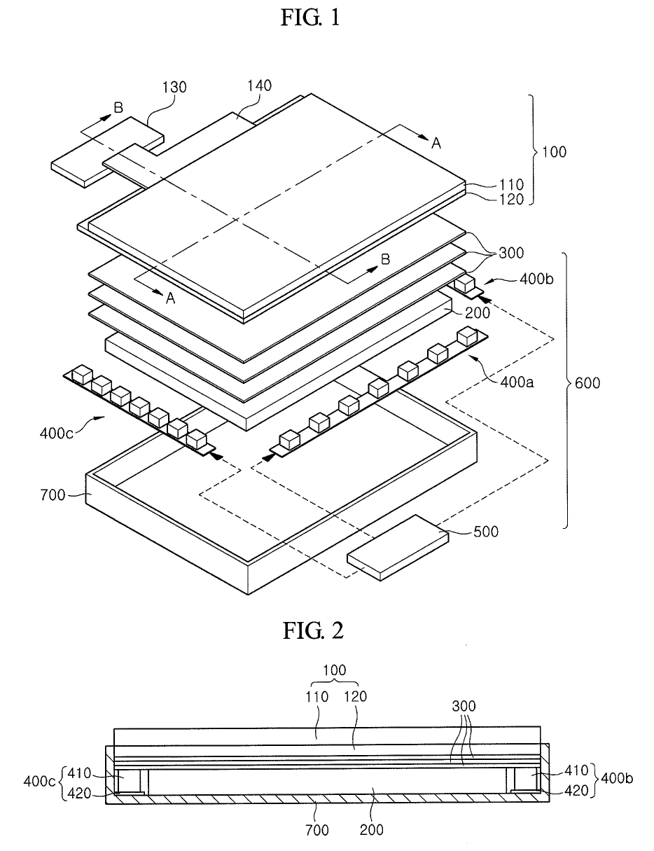

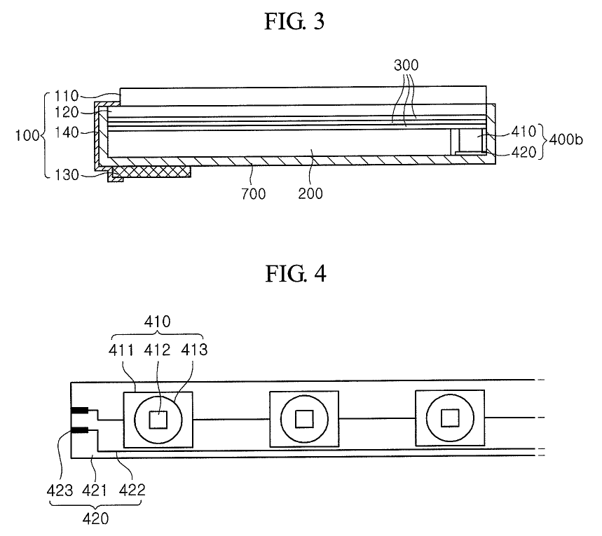

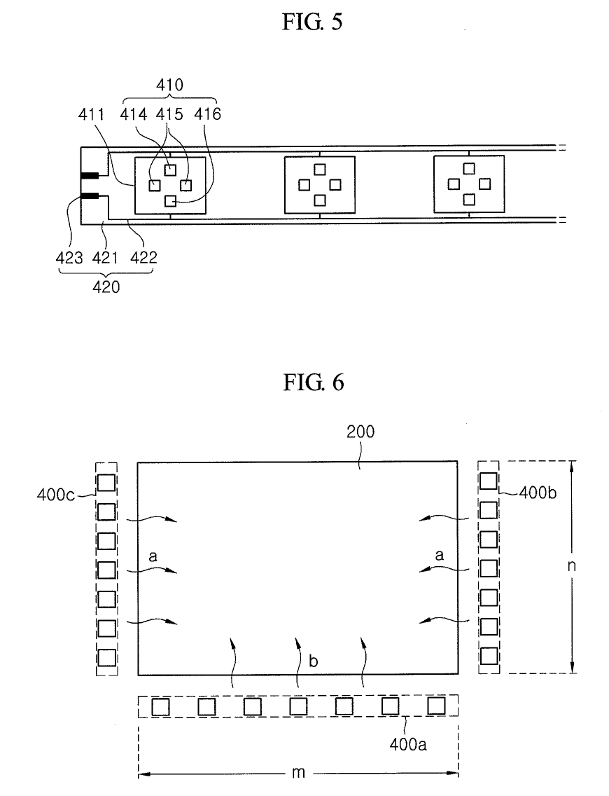

FIG. 1 is an exploded perspective view of a display device according to an exemplary embodiment of the present invention. FIG. 2 is a cross-sectional view of the assembled display device, taken along line A-A of FIG. 1. FIG. 3 is a cross-sectional view of the assembled display device, taken along line B-B of FIG. 1. FIG. 4 is a plan view of a light source according to an exemplary embodiment of the present invention. FIG. 5 is a plan view of a light source according to an exemplary embodiment of the present invention. FIG. 6 is a plan view of a light source module according to an exemplary embodiment of the present invention.

Referring to FIGS. 1 to 6, a display device includes a display panel 100 that displays an image, a light source module 600 that radiates light to the display panel 100, and a receiving member 700 that receives the display panel 100 and the light source module 600.

The display panel 100 includes an upper substrate 110, a lower substrate 120, and a liquid crystal layer (not shown) interposed therebetween. Further, the display panel 100 includes a control board 130 that is connected to the lower substrate 120 through a flexible printed circuit board 140.

R, G, B color filters, which display predetermined colors while light is transmitted therethrough, and light shielding patterns are formed on the upper substrate 110. A common electrode, which is made of a transparent electric conductor, such as an indium tin oxide (ITO) or an indium zinc oxide (IZO), is provided on the light shielding patterns and the color filters. The light shielding patterns and the color filters may be formed on the lower substrate 120, if necessary.

The lower substrate 120 includes a plurality of pixel electrodes that is arranged in a matrix, and thin film transistors that are connected to the plurality of pixel electrodes, respectively. Further, source terminals of the thin film transistors are connected to data lines, and gate terminals thereof are connected to gate lines. Furthermore, drain terminals of the thin film transistors are connected to the pixel electrodes. The pixel electrodes of the lower substrate 120 and the common electrode of the upper substrate 110 face each other and are spaced apart from each other. Accordingly, each of the pixel electrodes and the common electrode function as two electrode terminals of a capacitor. Liquid crystal interposed between the upper substrate 110 and the lower substrate 120 functions as a dielectric of the capacitor.

The control board 130 supplies predetermined signals to the gate lines and the data lines of the lower substrate 120, and the common electrode of the upper substrate 110. The control board 130 may include a gate driving unit that applies gate turn-on voltages to the gate lines, a data driving unit that supplies data signals to the data lines, a voltage generating unit that generates voltages used in driving circuits, and an operation control unit that controls operations of the data driving unit, the gate driving unit, and the voltage generating unit. The control board 130 may further include a clock generating unit that generates clocks. The gate driving unit, the data driving unit, and the voltage generating unit may be manufactured in the form of an IC chip, and may be mounted on the control board 130, for example. The units are not limited thereto, and a part of the gate driving unit, the data driving unit, and the voltage generating unit, which are manufactured in the form of an IC chip, may be mounted on the flexible printed circuit board 140 that connects the control board 130 with the lower substrate 120. Further, a part of the gate driving unit, the data driving unit, and the voltage generating unit, which are manufactured in the form of an IC chip, may be mounted on the lower substrate 120. Furthermore, the gate driving unit may be formed on the lower substrate 120. As shown in FIG. 3, the control board 130 is disposed on the lower surface of the receiving member 700 at a region adjacent to one edge thereof. In this case, the control board 130 is electrically connected to the lower substrate 120 by the flexible printed circuit board 140.

The operation of the display panel 100 will be briefly described below.

When the gate turn-on voltages are supplied to the gate lines through the control board 130, the thin film transistors connected to the gate lines are turned on. In this case, when image signals are supplied to the data lines through the control board 130, the image signals are supplied to the pixel electrodes through the source and drain terminals of the turned-on thin film transistors. For this reason, an electric field between the pixel electrodes of the lower substrate 120 and the common electrode of the upper substrate 110 varies. The reason for this is that electric potentials of the pixel electrodes are changed to correspond to the image signals. The arrangement of the liquid crystal interposed between the pixel electrode and the common electrode become varied due to the variance of the electric field. In this case, the light transmittance of the liquid crystal varies in correspondence to the arrangement of the liquid crystal. In this way, the display panel 100 can display a desired image when the light transmittance of the liquid crystal is varied.

The light source module 600 includes a light guide plate 200, an optical film unit 300, first to third light sources 400a, 400b, and 400c, and a power supply 500. The light guide plate 200 has a shape of a substantially rectangular plate, and the optical film 15 unit 300 is provided on the light guide plate 200. The first to third light sources 400a, 400b, and 400c are disposed adjacent to three side surfaces of the light guide plate 200, and the power supply 500 applies corresponding light-emitting voltages to the first to third light sources 400a, 400b, and 400c.

The light guide plate 200, which is formed substantially in the shape of a rectangular plate, changes light emitted from light sources 400 that have an optical distribution of a spot or line light source into light that has an optical distribution of a surface light source. Polymethylmethacrylate (PMMA), which is not easily deformed or broken and has excellent transmittance, can be used as the light guide plate 200. Further, optical patterns such as prisms may be formed on the surface of the light guide plate 200. The light guide plate 200 receives light through the side surfaces thereof, and emits the light from the upper surface thereof. Although not shown, a reflecting plate may be provided on the lower surface of the light guide plate 200. The reflecting plate reflects the light, which is radiated through the lower surface of the light guide plate 200, to the upper surface of the light guide plate 200.

The optical film unit 300 includes one or more luminance improving sheets and one or more diffusion sheets. The luminance improving sheet transmits light radiated in a direction parallel to the transmission axis thereof, and reflects light radiated in other directions. The diffusion sheet diffuses light incident from the light guide plate 200 so that the incident light has uniform distribution in a wide region. In this case, the optical film unit 300 may further include a diffusion plate having the same function as the diffusion sheet. Furthermore, the optical film unit 300 may include various optical sheets or optical plates that change the characteristic of light, if necessary.

Each of the first to third light sources 400a, 400b, and 400c includes a plurality of light-emitting units 410 and a substrate 420 on which the plurality of light-emitting units 410 is mounted.

As shown in FIG. 4, each of the light-emitting units 410 includes a body 411, a light-emitting diode 412 provided in the body 411, and a fluorescent substance 413 covering the light-emitting diode 412. In this case, a blue light-emitting diode can be used as the light-emitting diode 412 and a yellow fluorescent substance can be used as the fluorescent substance 413. The embodiments of the present invention are not limited thereto. For example, as shown in FIG. 5, each of the light-emitting units 410 may include a body 411, a red light-emitting diode 414, a blue light-emitting diode 415, and a green light-emitting diode 416 that are provided in the body 411.

A printed circuit board can be used as the substrate 420. The embodiments of the present invention are not limited thereto, and a flexible printed circuit board may be used as the substrate 420. In this case, the substrate 420 is formed in the shape of a bar. In this case, the substrate 420 includes an insulating substrate body 421 having the shape of a bar, a plurality of power wires 422 formed on the insulating substrate body 421, and power terminals 423 provided at the ends of the power wires 422. As shown in FIG. 4, the light-emitting units 410 mounted on the substrate 420 are connected to one another in series by the power wires 422. The embodiments of the present invention are not limited thereto, and the light-emitting units 410 mounted on the substrate 420 may be connected to one another in parallel by the power wires 422 as shown in FIG. 5. The embodiments of the present invention are not limited thereto, and the light-emitting units 410 may be connected to one another in series and parallel, or they may be reversely connected to one another in parallel.

Power is applied to the power supply 500 from the outside, and the power supply 500 applies voltages, which are used for controlling the light emission of the light-emitting units 410, to the power terminals 423 of the substrate 420. The power supply 500 is attached to the outer surface of the bottom of the receiving member 700. Further, the power supply 500 is connected to the power terminals 423 of the substrate 420 by wires extending through the receiving member 700. In this case, the brightness (luminance) of the light-emitting units 410 can be varied depending on the voltages applied by the power supply 500.

As described above, the first to third light sources 400a, 400b, and 400c are disposed adjacent to three side surfaces of the light guide plate 200, respectively. Accordingly, the light guide plate 200 receives light through three side surfaces thereof, and emits the light from the upper surface thereof. As shown in FIG. 6, the first to third light sources 400a, 400b, and 400c are disposed adjacent to one long side surface and two short side surfaces of the light guide plate 200, respectively. In this case, the long side surface is a side surface corresponding to one long side among four sides of the rectangular light guide plate 200. The short side surfaces are side surfaces corresponding to two short sides among four sides of the rectangular light guide plate 200.

The first light source 400a is disposed adjacent to the long side surface, and the second and third light sources 400b and 400c are disposed adjacent to both short side surfaces, respectively. Since the light sources 400 are disposed adjacent to three side surfaces of the light guide plate 200 as described above, it is possible to prevent the over-concentration of the light-emitting units 410 in the light sources 400. Further, since the second and third light sources 400b and 400c are disposed adjacent to both short side surfaces of the light guide plate 200, the light guide plate 200 can emit light having uniform luminance. Furthermore, the control board 130 of the display panel 100 is disposed at a region adjacent to one long side surface. Accordingly, the first light source 400a can be disposed adjacent to the other long side surface of the light guide plate 200 facing the long side surface thereof at which the control board 130 is disposed. This is done to reduce heat stress applied to the light sources 400 due to heat generated from the control board 130. Further, if the control board 130 is adjacent to the light sources 400, the display panel 100 may be abnormally operated due to the heat generated from the control board 130 and the light sources 400. Accordingly, the first to third light sources 400a, 400b, and 400c are generally not disposed at the same side surface as the control board 130.

Further, the output luminance of the first light source 400a disposed adjacent to one long side surface can be larger than the output luminance of each of the second and third light sources 400b and 400c disposed adjacent to both short side surfaces. In this case, the output luminance of the second and third light sources 400b and 400c disposed adjacent to both short side surfaces can be equal or similar to each other. In this case, one side being equal or similar to another means that one side is equal or similar to another in an error range.

This is done because the length of the long side surface of the light guide plate 200 is different from that of the short side surface thereof. For example, if the target luminance of the light to be output from the light guide plate 200 is 300, each of the first to third light sources 400a, 400b, and 400c does not radiate light having the luminance of 100; instead, the luminance of the light radiated from the first light source 400a and the luminance of the light radiated from each of the second and third light sources 400b and 400c are different from each other such that the difference corresponds to the ratio of the length of the long side surface of the light guide plate 200 to the length of the short side surface thereof. For example, a case when a ratio of the length “m” of the long side surface to the length “n” of the short side surface is 16:9 (m:n) will be described below. In this case, the luminance of the light radiated from each of the second and third light sources 400b and 400c is assumed as “a”, and the luminance of the light radiated from the first light source 400a is assumed as “b”. Further, light is radiated in a direction parallel to the long side of the light guide plate 200 to correspond to the luminance of “a”, and light is radiated in a direction parallel to the short side of the light guide plate 200 to correspond to the luminance of “b”. Therefore, an expression “16:9=2a:b” is obtained, such that an expression “a=8b/9” is obtained. In this case, assuming that the luminance of the light radiated to the light guide plate 200 is 300, an expression “300=2a+b” is obtained. If using the expression “a=8b/9”, it is possible to obtain an expression “300=2(8b/9)+b”. As a result, “b” is 108 and “a” is 96.

When the target luminance is 300 as described above, the first light source 400a emits light having the luminance of 108 and the second and third light sources 400b and 400c emit light having the luminance of 96. In this case, light emitted from each of the second and third light sources 400b and 400c reaches the short side surface opposite to the short side surface through which it is radiated. Accordingly, the light emitted from each of the second and third light sources 400b and 400c complements the luminance thereof. Therefore, the light emitted from each of the second and third light sources 400b and 400c can have a luminance smaller than the above-mentioned result (96). In this case, the luminance of the light emitted from each of the second and third light sources 400b and 400c can be 50% of the above-mentioned result (96). However, when each of the second and third light sources 400b and 400c emits light having a luminance smaller than 50% of the above-mentioned result (96), the target luminance is not obtained because the amount of light radiated through both short side surfaces of the light guide plate 200 is too small.

The above description will be generalized below. For example, assuming that the lengths of the long and short sides of the light guide plate 200 are defined as m and n, respectively, the luminance of the light radiated from each of the second and third light sources 400b and 400c is “a”, the luminance of the light radiated from the first light source 400a is “b”, and the target luminance is “L”, it is possible to obtain the expression “m/2:n=a:b”. Accordingly, the expression “a=((m/2)b)/n” is obtained. In this case, since the expression “L=2a+b” is obtained, it is possible to obtain the expression “L=2((m/2)b)n)+b”. The expression “b=nL/(m+n)” and the expression “a=(n/2)(mL/(m+n))(1/n)” are obtained from the above-mentioned expressions. In this case, “a” is larger than (½)(n/2)(mL/(m+n))(1/n) and equal to or smaller than (n/2)(mL/(m+n))(1/n).

As described above, the amount of light radiated to the light guide plate 200 through the long side surface of the light guide plate 200 and the amount of light radiated to the light guide plate 200 through both short side surfaces of the light guide plate 200 are set to be different from each other, so that the light guide plate 200 can emit light having uniform luminance.

For this purpose, the luminance of the light radiated from the first light source 400a through the long side surface and the luminance of the light emitted from each of the second and third light sources 400b and 400c are different from each other. In this case, the number of light-emitting units 410 of the first light source 400a and the number of the light-emitting units 410 of each of the second and third light sources 400b and 400c are set to be different from each other. For example, when the luminance of light emitted from one light-emitting unit 410 is 10, about eleven light-emitting units 410 are provided in the first light source 400a and nine light-emitting units 410 are provided in each of the second and third light sources 400b and 400c. The embodiments of the present invention are not limited thereto. For example, an output voltage applied to the first light source 400a may be set to be larger than an output voltage applied to each of the second and third light sources 400b and 400c so that the luminance of the light emitted from the first light source 400a though the long side surface and the luminance of the light emitted from each of the second and third light sources 400b and 400c are different from each other. In this case, the number of the light-emitting units 410 of each of the first to third light sources 400a, 400b, and 400c is the same. In this case, a voltage corresponding to the luminance of 108 is applied to the first light source 400a, and a voltage corresponding to the luminance of 96 is applied to each of the second and third light sources 400b and 400c. Further, the embodiments of the present invention are not limited thereto. For example, as described above, the number of the light-emitting units 410 of the first light source 400a may be different from the number of the light-emitting units 410 of each of the second and third light sources 400b and 400c, and an output voltage applied to the first light source 400a may be different from an output voltage applied to each of the second and third light sources 400b and 400c.

The light source module 600 is assembled in the receiving member 700. For example, the light guide plate 200 is disposed on the inner surface of the bottom of the receiving member 700. In this case, the second and third light sources 400b and 400c are disposed adjacent to both short side surfaces of the light guide plate 200, respectively, and the first light source 400a is disposed adjacent to one long side surface of the light guide plate 200. The optical film unit 300 is disposed on the light guide plate 200. As a result, the light source module 600 is manufactured. After that, the display panel 100 is disposed on the light source module 600, so that the display device is manufactured. In this case, the control board 130 of the display panel 100 is positioned on the outer surface of the bottom of the receiving member 700. In this case, the control board 130 is disposed adjacent to the long side surface of the light guide plate 200 facing the long side surface at which the first light source 400a is disposed.

The embodiments of the present invention are not limited thereto. For example, the light-emitting units 410 of the light sources 400b and 400c adjacent to the short side surfaces can be divided into a plurality of light-emitting blocks, and the light-emitting blocks may have a different output luminance. An exemplary embodiment of the present invention where the light-emitting blocks have a different output luminance will be described below. Any descriptions of elements previously described will be omitted in the following description so as to avoid repetition.

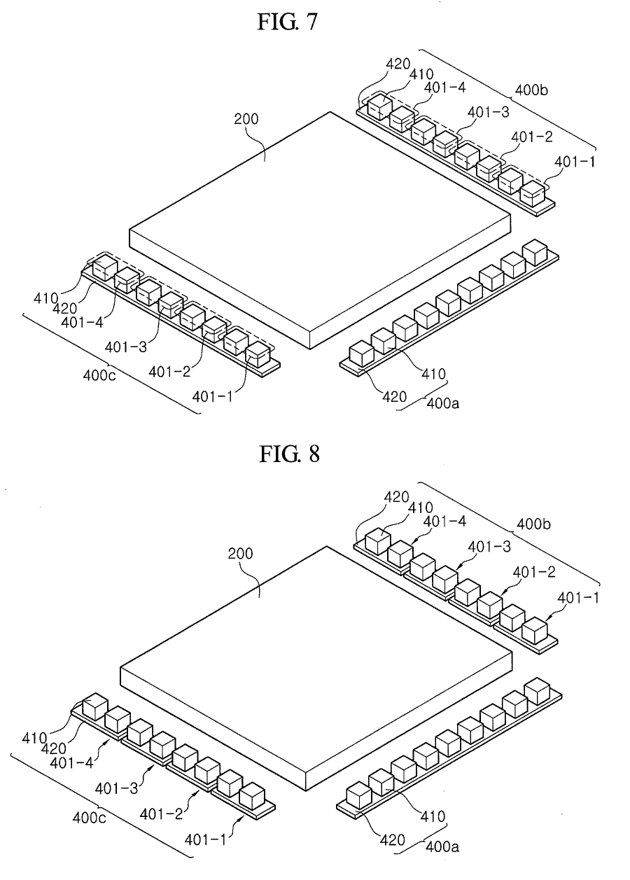

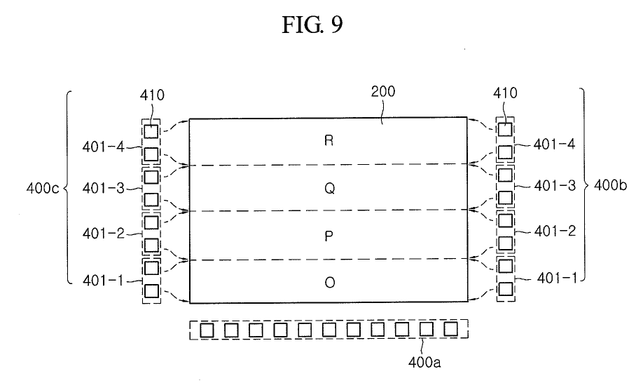

FIG. 7 is an exploded perspective view of a light source module according to an exemplary embodiment of the present invention. FIG. 8 is an exploded perspective view of a light source module according to an exemplary embodiment of the present invention. FIG. 9 is a plan view of a light source module according to an exemplary embodiment of the present invention.

Referring to FIGS. 7 to 9, a light source module 600 includes a light guide plate 200, and first to third light sources 400a, 400b, and 400c that are disposed adjacent to three side surfaces of the light guide plate 200.

Each of the second and third light sources 400b and 400c includes a plurality of light-emitting blocks (401) 401-1, 401-2, 401-3, and 401-4. Each of the light-emitting blocks 401 includes one or more light-emitting units 410. Each of the second and third light sources 400b and 400c includes a substrate 420 on which the plurality of light-emitting blocks (401) 401-1, 401-2, 401-3, and 401-4 is mounted. Although not shown, a plurality of wires is provided to the substrate 420. The plurality of wires is electrically connected to the plurality of light-emitting blocks (401) 401-1, 401-2, 401-3, and 401-4, respectively.

In this case, the light-emitting blocks 401 have a different output luminance. For example, the plurality of light-emitting blocks 401 is sequentially disposed along the short side surfaces, and the luminance of the light-emitting blocks 401 is sequentially increased from the light-emitting block adjacent to the first light source 400a. As shown in FIG. 7, each of the second and third light sources 400b and 400c includes four light-emitting blocks, that is, the first to fourth light-emitting blocks 401-1, 401-2, 401-3, and 401-4. The first to fourth light-emitting blocks 401-1, 401-2, 401-3, and 401-4 are sequentially disposed along each of the short side surfaces. In this case, the first light-emitting block 401-1 is disposed adjacent to the first light source 400a, and the fourth light-emitting block 401-4 is disposed at a position farthest from the first light source 400a. Accordingly, the output luminance of the first light-emitting block 401-1 is lowest, and the output luminance of the fourth light-emitting block 401-4 is highest.

As shown in FIG. 9, the output luminance of each of the first to fourth light-emitting blocks 401-1, 401-2, 401-3, and 401-4 of each of the second and third light sources 400b and 400c has a large effect on the output luminance of an O region or an R region of the light guide plate 200. Further, the output luminance of the first light source 400a has a large effect on the output luminance of the O region or the R region of the light guide plate 200. This is caused by the difference in the radiation distance of the light that is radiated to the light guide plate 200. For example, light radiated to the light guide plate 200 through the side surfaces of the light guide plate 200 is diffused (advances) while being reflected. In this case, as the light radiated into the light guide plate 200 advances, the luminance of the light is decreased. For example, the luminance of the light radiated from the first light source 400a to the light guide plate 200 is sequentially decreased at an O region, a P region, a Q region, and an R region.

Accordingly, if the first to fourth light-emitting blocks 401-1, 401-2, 401-3, and 401-4 emit light having the same luminance, output luminance is highest at the O region of the light guide plate 200 due to the effect of the first light source 400a and the output luminance becomes lower toward the R region. Therefore, the first to fourth light-emitting blocks 401-1, 401-2, 401-3, and 401-4 have a different output luminance, so that the overall luminance of the light radiated from the light guide plate 200 can be made uniform. For example, the output luminance of the fourth light-emitting block 401-4 is set to be the highest, to increase the output luminance at the R region where the output luminance is the lowest due to the first light source 400a. As a result, the luminance of the light radiated from the entire surface of the light guide plate 200 is made uniform.

For this purpose, voltages applied to the first to fourth light-emitting blocks 401-1, 401-2, 401-3, and 401-4 are set to be different from one another so that the output luminance thereof is controlled. For example, the lowest voltage is applied to the first light-emitting block 401-1, and the highest voltage is applied to the fourth light-emitting block 401-4. The embodiments of the present invention are not limited thereto. For example, the number of light-emitting units 410 of the first to fourth light-emitting blocks 401-1, 401-2, 401-3, and 401-4 may be set to be different from one another. The number of the light-emitting units 410, which emit light having the same luminance, of the first light-emitting block 401-1 may be set to be the smallest, and the number of the light-emitting units 410 of the fourth light-emitting block 401-4 may be set to be the largest. In this case, the entire luminance of the first to fourth light-emitting blocks 401-1, 401-2, 401-3, and 401-4 can be equal to the luminance of the second and third light sources 400b and 400c as described above.

In the above-mentioned embodiments, the first to fourth light-emitting blocks 401-1, 401-2, 401-3, and 401-4 have been mounted on a single substrate 420 and have formed a single light source. However, the embodiments of the present invention are not limited thereto, and the first to fourth light-emitting blocks 401-1, 401-2, 401-3, and 401-4 may form independent light sources as shown in FIG. 8. In FIG. 8, each of the light sources includes a substrate 420, and a plurality of light-emitting units 410 mounted on the substrate 420. In this case, a light-emitting diode is used as the light-emitting unit 410. However, the embodiments of the present invention are not limited thereto, and the light-emitting block 401 may include Cold Cathode Fluorescent Lamps (CCFLs), External Electrode Fluorescent Lamps (EEFLs), and various other fluorescent discharge lamps.

As described above, the embodiments of the present invention provide a light source module for a display device and a display device having the light source module. In the light source module, light sources including light emitting diodes are disposed at three side surfaces of a light guide plate, and the brightness of the light sources is set to be different from one another so that they meet a target luminance. Therefore, light having uniform luminance can be radiated on the entire surface of the light guide plate. Further, by controlling the brightness of the light emitted from the light sources, the heat radiated therefrom is dispersed such that damage to nearby electronic circuits can be prevented and its effects on light radiated from the light guide plate can be alleviated.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A light source module comprising:
a light guide plate having first side surfaces opposite each other and second side surfaces opposite each other, wherein each of the first side surfaces has a length of m and each of the second side surfaces has a length of n, and wherein n≦m;
a first light source that is disposed adjacent to one of the first side surfaces; and
second and third light sources that are disposed adjacent to the second side surfaces, respectively,
wherein an output luminance of the first light source is different from an output luminance of each of the second and third light sources.

2. The light source module of claim 1, wherein when an output luminance of the light guide plate is L, the output luminance of each of the second and third light sources is larger than (½)(n/2)(mL/(m+n))(1/n) and equal to or smaller than (n/2)(mL/(m+n))(1/n).

3. The light source module of claim 2, wherein the output luminance of the first light source is nL/(m+n).

4. The light source module of claim 1, wherein each of the first to third light sources includes a plurality of light-emitting units, and
each of the plurality of light-emitting units includes one or more light-emitting diodes.

5. The light source module of claim 4, wherein the number of the light-emitting units of the first light source is larger than the number of the light-emitting units of each of the second and third light sources.

6. The light source module of claim 1, wherein the output luminance of the first light source is higher than the output luminance of each of the second and third light sources.

7. The light source module of claim 1, wherein each of the second and third light sources includes a plurality of light-emitting blocks that are sequentially disposed along the second side surfaces, and
a luminance of each of the plurality of the light-emitting blocks is sequentially increased from a light-emitting block adjacent to the first light source to a light-emitting block farthest from the first light source.

8. The light source module of claim 7, wherein a light-emitting block comprises one or more light-emitting diodes, one or more Cold Cathode Fluorescent Lamp(CCFLs), or one or more External Electrode Fluorescent Lamp (EEFLs).

9. A light source module comprising:
a light guide plate having first side surfaces opposite each other and second side surfaces opposite each other, wherein each of the first side surfaces has a length of m and each of the second side surfaces has a length of n, and wherein n≦m;
a first light source that is disposed adjacent to one of the first side surfaces; and
second and third light sources that are disposed adjacent to the second side surfaces, respectively,
wherein each of the second and third light sources includes a plurality of light-emitting blocks that are sequentially disposed along the second side surfaces, and
a luminance of each of the plurality of the light-emitting blocks is sequentially increased from a light-emitting block adjacent to the first light source to a light-emitting block farthest from the first light source.

10. The light source module of claim 9, wherein each of the light-emitting blocks includes one or more light-emitting diodes, and a substrate on which the light-emitting diodes are mounted.

11. The light source module of claim 9, wherein when an output luminance of the light guide plate is L, an output luminance of the first light source is nL/(m+n), and the sum of an output luminance of the light-emitting blocks of each of the second and third light sources is larger than (½)(n/2)(mL/(m+n))(1/n) and equal to or smaller than (n/2)(mL/(m+n))(1/n).

12. A display device comprising:
a light source module including:
a light guide plate having first side surfaces opposite each other and second side surfaces opposite each other, wherein each of the first side surfaces has a length of m and each of the second side surfaces has a length of n, and wherein n≦m,
a first light source that is disposed adjacent to one of the first side surfaces and that emits light having a first output luminance, and
second and third light sources that are disposed adjacent to the second side surfaces, respectively, wherein each of the second and third light sources emits light having a second output luminance; and
a display panel that displays an image by using light radiated from the light source module.

13. The display device of claim 12, further comprising:
a control board that supplies image signals to the display panel,
wherein the control board is disposed adjacent to the first side surface opposite the first side surface having the first light source disposed adjacent thereto.

14. The display device of claim 12, wherein the first output luminance is higher than the second output luminance.

15. The display device of claim 12, wherein when an output luminance of the light guide plate is L, the second output luminance is larger than (½)(n/2)(mL/(m+n))(1/n) and equal to or smaller than (n/2)(mL/(m+n))(1/n).

16. The display device of claim 15, wherein the first output luminance is nL/(m+n).

17. The display device of claim 12, wherein each of the second and third light sources includes a plurality of light-emitting blocks that are sequentially disposed along the second side surfaces, and
a luminance of each of the plurality of the light-emitting blocks is sequentially increased from a light-emitting block adjacent to the first light source to a light-emitting block farthest from the first light source.

18. The display device of claim 12, wherein the first output luminance is different from the second output luminance.

19. The display device of claim 12, wherein each of the first to third light sources includes a plurality of light-emitting units, and each of the plurality of light-emitting units includes one or more light-emitting diodes.

20. The display device of claim 19, wherein the number of the light-emitting units of the first light source is larger than the number of the light-emitting units of each of the second and third light sources.
